(19) United States
(12) Patent Application Publication
(10) Pub. No.: US 2007/0125869 A1
(43) Pub. Date: Jun. 7, 2007

(54) Memory card with protected test contacts

(75) Inventor: Ping-Yang Chuang, Taipei City (TW)

Correspondence Address: RABIN & Berdo, PC, 1101 14TH STREET, NW, SUITE 500, WASHINGTON, DC, 20005, US

(73) Assignees: A-DATA TECHNOLOGY CO., LTD., Taipei (TW); PING-YANG CHUANG, Taipei City (TW)

(21) Appl. No.: 11/603,148

(22) Filed: Nov. 22, 2006

(30) Foreign Application Priority Data
Dec. 5, 2005 (TW) 094221120

(51) Int. Cl. G06K 19/06

(52) U.S. Cl. 235/492

(57) ABSTRACT

A memory card with test contacts having protection on an interface is provided. The claimed memory card comprises a card body having a circuit board therein, a control chip on the circuit board used to control data reading and writing of the memory card, a memory chip on the circuit board used to store data for the memory card, a memory card interface electrically connecting to the control chip, a connection interface, electrically connecting control chip, and a lid or a tab on the memory card interface or on the connection interface to protect test contacts on the interfaces.

### BACKGROUND OF THE INVENTION

1. Field of the Invention

The invention generally relates to a memory card with protected test contacts by using an insulating lid or tab covering the test contacts.

2. Description of the Related Art

Memory cards have been applied to various electronic products such as personal computers, laptops, personal digital assistants, MP3, MP4 and digital cameras due to their large memory capacity, small size, and portability. Currently commercial available memory cards includes SD (security digital) memory card, Micro_SD memory card, MiniSD memory card, CF (compact flash) card, MS (memory stick) card, SM (smart media) card and MMC (multi media card). A plurality of metallic-contacts on interfaces of those memory cards are exposed without any protection. Therefore, such memory cards would be damaged if static electricity generates when users touch the metallic contacts or if users incautiously apply undue voltage to the metallic contacts on the interfaces of the memory cards.

### SUMMARY OF THE INVENTION

It is one of objects of the invention to provide a memory card that prevents any damage due to static electricity between user's touch and metallic contacts or due to undue voltage applied by users to metallic contacts.

In order to achieve the above and other objectives of the invention, the memory card with protected test contacts according to the invention includes a card body having a circuit board therein, and a control chip on the circuit board used to control data reading and writing of the memory card, and a memory chip on the circuit board used to store data for the memory card, and a memory card interface electrically connecting to the control chip, and a connection interface electrically connecting control chip, and a lid or tab on the memory card interface or on the connection interface to protect test contacts on the interfaces.

The lid or tab is torn off from the memory card of the invention to expose the test contacts underneath the lid or tab for maintaining and analyzing electrical properties of the memory card, examining content of the memory card, certifying the performance of the memory card, and being compatible with the use of double interfaces.

Furthermore, users can inform memory card producers from time to time of whether there is a compatibility-related problem for the memory card they are using. When the memory card is read by an electronic product such as digital camera, personal digital assistant, personal computer, laptop, MP3 or MP4, the configuration of the memory card according to the invention provides several advantages including previously avoiding potential profit loss for memory card producers, creating and keeping the brand value of memory cards, and protecting the users' interest.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is a perspective view of a memory card according to the invention;

FIG. 2 is a schematic view showing an interior of a memory card according to the invention;

FIG. 3 is a block diagram of a memory card according to the invention;

FIG. 4 illustrates a lid or tab attached on test contacts of interfaces of a memory card according to one embodiment of the invention;

FIG. 5 illustrates a lid or tab attached on test contacts of interfaces of a memory card according to another embodiment of the invention;

FIG. 6 is a schematic view showing the status of a memory card before test according to the invention; and

FIG. 7 is a schematic view showing the status of a memory card during test according to the invention.

### DETAILED DESCRIPTION OF THE EMBODIMENTS

Wherever possible in the following description, like reference numerals will refer to like elements and parts unless otherwise illustrated.

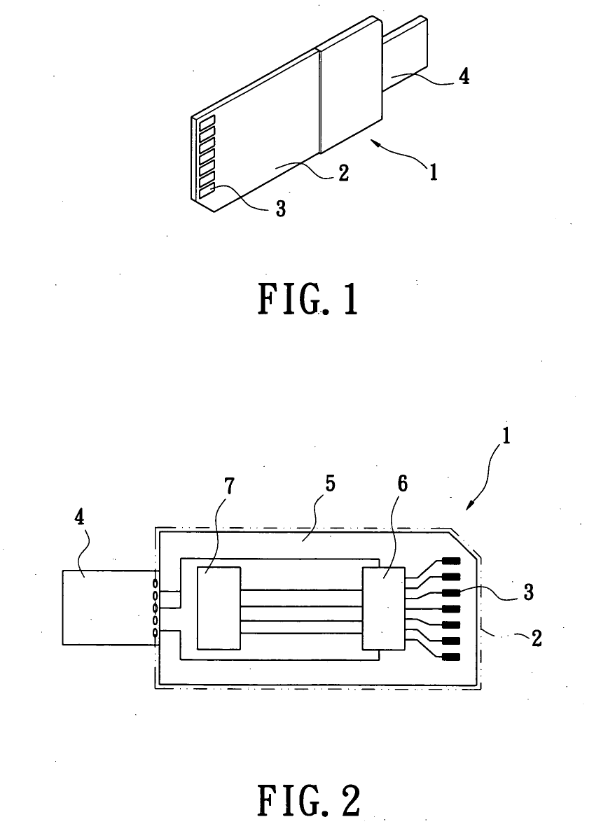

FIG. 1 is a schematic perspective view of a memory card 1 according to the invention. Referring to FIG. 1, the memory card 1 includes a card body 2, a memory interface 3 and a connection interface 4. The memory card interface 3 can be a SD memory card, Micro_SD memory card, MiniSD memory card, CF card, MS card, SM card and MMC, for example. The connection interface 4 can be a serial bus RS232, universal bus (USB) or an IEEE 1394 interface.

FIG. 2 is a schematic view showing an interior of the memory card 1 according to the invention. Referring to FIG. 2, a circuit board 5 locates inside the card body 2, and electrically connects to the memory card interface 3 and the connection interface 4. The circuit board 5 further has a control chip 6 and a memory chip 7 thereon. The control chip 6 electrically connects to the memory card interface 3. The memory card chip 7 electrically connects to the connection interface 4 and the control chip 6.

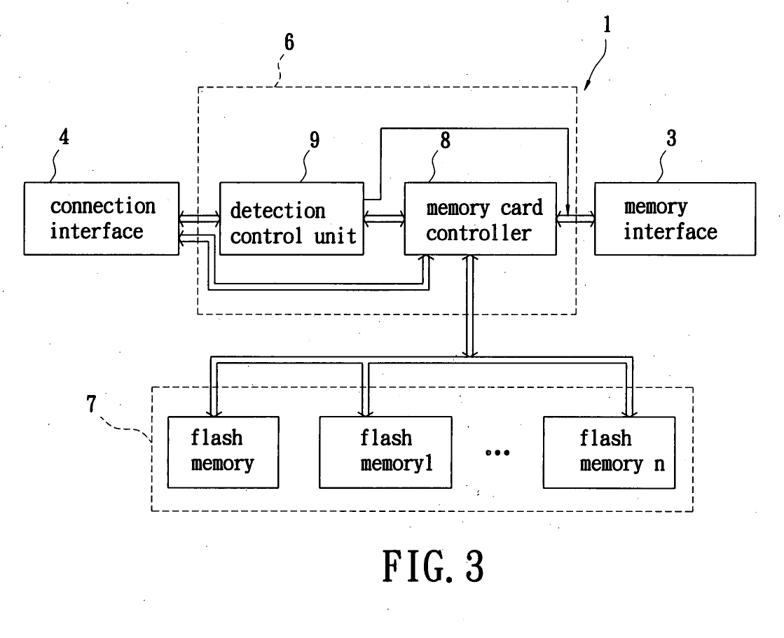

FIG. 3 is a block diagram of a memory card 1 according to the invention. The control chip 6 includes a memory card controller 8 and a detection control unit 9. The control chip 7 includes n flash memories, wherein n is an integral, greater than 1. Furthermore, the memory chip 7 also includes n read-only memories, wherein n is an integral greater than 1.

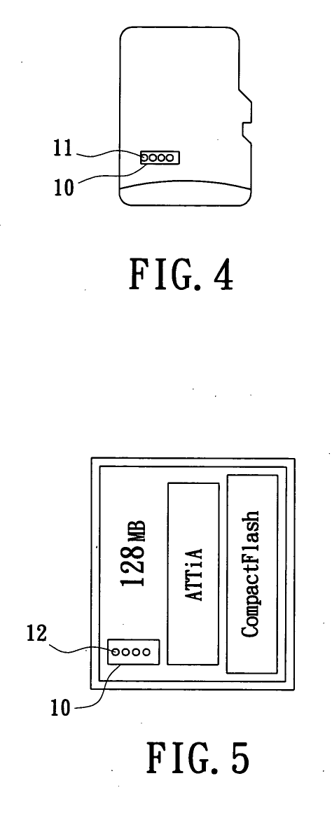

FIG. 4 and FIG. 5 respectively illustrate a lid or tab 10 attached on the connection interface 4 or the memory card interface 3 to protect test contacts 11 or 12. The lid or tab 10 is an unrecoverable non-conductive sheet, which forms an electrical insulation for the test contacts 11 or 12 on the interfaces. The test contacts 11 and 12 are made of metals which do not tend to be oxidized. The test contacts 11 and 12 are used for users to maintain and analyze electrical properties of the memory card 1, examine content of the memory card 1 and certify the performance of the memory card.

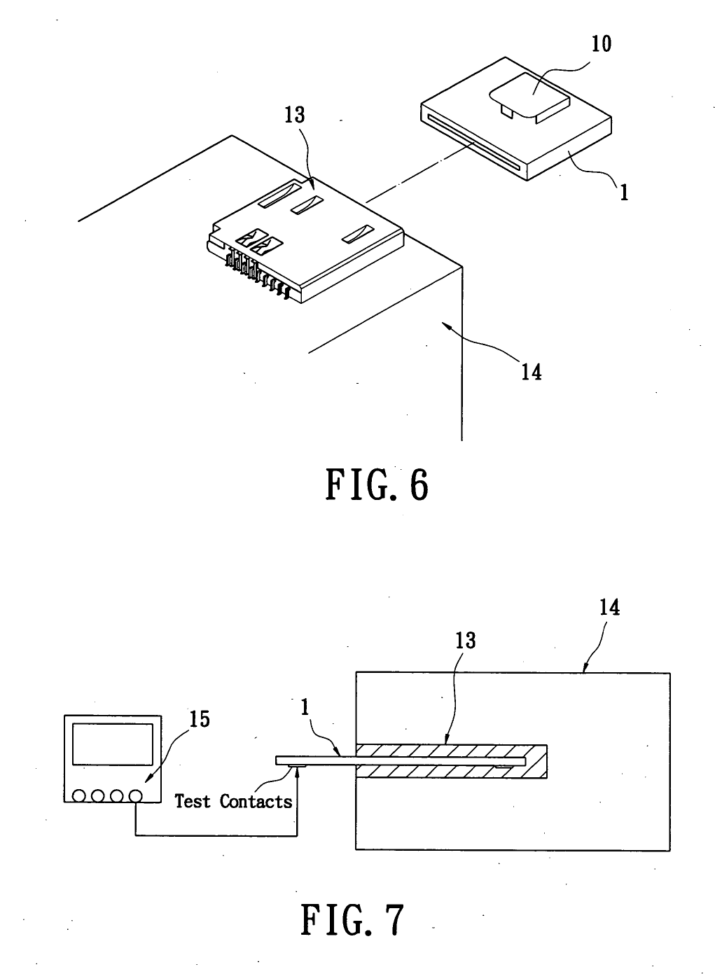

FIG. 6 and FIG. 7 are schematic views respectively showing the status of the memory card 1 before and during the test according to the invention. During the test, the user tears the lid or tab 10 off and then inserts the memory card 1 into a slot 13. The test contacts 11 or 12 connect to a testing device 15. Finally, a device 14 provides power supply to the memory card 1 for test.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A memory card with protected test contacts on an interfaces, the memory card comprising:
a card body, having a circuit board therein;
a control chip on the circuit board, used to control data reading and writing of the memory card;
a memory chip on the circuit board, used to store data for the memory card;
a memory card interface, electrically connecting to the control chip;
a connection interface, electrically connecting control chip; and
a lid or tab on the memory card interface or on the connection interface to protect test contacts on the interfaces.

2. The memory card of claim 1, wherein the memory chip has a plurality of flash memories.

3. The memory card of claim 1, wherein the memory chip has a plurality of read-only memories.

4. The memory card of claim 1, wherein the lid or tab is one-use non-conductive sheet.

5. The memory card of claim 1, wherein the control chip includes a memory card controller and a detection control unit.

6. The memory card of claim 1, wherein the connection interface is a serial bus RS232, universal bus (USB) or an IEEE 1394 interface.

7. The memory card of claim 1, wherein the memory card is SD memory card, Micro_SD memory card, MiniSD memory card, CF card, MS card, SM card or MMC.
